(19) United States
(12) Patent Application Publication
(10) Pub. No.: US 2026/0183779 A1
(43) Pub. Date: Jul. 2, 2026

(54) FLUID PRODUCT DISPENSER

(71) Applicant: APTAR FRANCE SAS, Le Neubourg (FR)

(72) Inventors: Sébastien BILQUEZ, Marcilly sur Eure (FR); Alex MILIAN, Les Baux de Breteuil (FR)

(73) Assignee: APTAR FRANCE SAS, Le Neubourg (FR)

(21) Appl. No.: 18/864,105

(22) PCT Filed: May 10, 2023
(86) PCT No.: PCT/FR2023/000092

§ 371 Date: Nov. 8, 2024

(30) Foreign Application Priority Data
May 11, 2022 (FR) FR2204466

(51) Int. Cl. B05B 11/00; B05B 11/10

(52) U.S. Cl. CPC B05B 11/0038; B05B 11/0054; B05B 11/1035; B05B 11/1047

(57) ABSTRACT

A fluid product dispenser having a reservoir forming a neck defining an annular upper edge; an outer casing having a threaded bushing defining a central opening for passage of the neck, the reservoir extending in the casing along a longitudinal axis X; a dispensing member with a threaded ring for engagement with the threaded bushing of the outer casing, the dispensing member bearing axially on the neck when the threaded ring is screwed onto the threaded. The neck and threaded bushing form an axial abutment for axially locking the neck in the threaded bushing by axial thrust of the dispensing member on the neck. The outer casing has an outer shell forming a threaded upper edge, and a cover having a threaded skirt for engagement with the threaded upper edge of the outer shell, the cover forming the threaded bushing defining the central opening for the passage of the neck.

The present invention relates to a fluid product dispenser and more particularly to a refillable dispenser. This dispenser comprises a reservoir forming a neck, as well as an outer casing forming a threaded bushing defining a central opening for the passage of the neck. The dispenser also comprises a dispensing member provided with a threaded ring to be screwed onto the threaded bushing. Preferably, the neck of the reservoir is removably or reversibly held in the outer casing in a manner such that a user can remove the reservoir from the casing in order to replace it with another reservoir. The advantageous fields of application of the invention are those of cosmetics, housekeeping products or foodstuffs.

Reservoirs with a flexible pouch inherently lack strength or rigidity, since advantage is taken precisely of the deformation of the flexible pouch in order to reduce the useful volume of the reservoir as the fluid product is extracted therefrom by the dispensing member. Mounting the dispensing member on the neck of the reservoir or on the casing while guaranteeing sealing of the dispenser is therefore complicated, because of the freedom of movement of the flexible pouch inside the casing. Sealed mounting of the dispensing member on the neck of the reservoir or on the casing is complicated further, because the reservoir is introduced into the casing via the open bottom of the casing and mounting is carried out by screwing.

The aim of the present invention is to be able to screw the dispensing member onto the casing while guaranteeing that the neck is securely held in the casing and that the seal between the neck and the dispensing member is perfect.

To this end, the present invention proposes a fluid product dispenser comprising:
a fluid product reservoir forming a neck defining an annular upper edge,
an outer casing comprising a threaded bushing defining a central opening for the passage of the neck, the fluid product reservoir extending in the casing along a longitudinal axis X,
a dispensing member provided with a threaded ring intended to come into threaded engagement with the threaded bushing of the outer casing, the dispensing member coming to bear axially on the neck when screwing of the threaded ring onto the threaded bushing is complete,
the neck and the threaded bushing together forming axial abutment means for axially locking the neck in the threaded bushing by axial thrust of the dispensing member on the neck,
   characterized in that the outer casing comprises:
an external shell forming a threaded upper edge, and
a cover comprising a threaded skirt intended to come into threaded engagement with the threaded upper edge of the outer shell, the cover forming the central opening for the passage of the neck of the rigid end piece.

In other words, the dispensing member is secured on the outer casing by screwing, but also comes into engagement with the neck of the reservoir in order to bring about the axial abutment between the neck and the threaded bushing. The neck is therefore held securely both with respect to the outer casing and with respect to the dispensing member. The axial thrust exerted on the neck by the dispensing member may be used to produce a seal between the neck and the dispensing member, for example by compressing a neck seal onto the annular upper edge of the neck. In a variation, the dispensing member may comprise a self-sealing lip that comes into sliding radial contact inside the neck.

In a refillable dispenser, the axial abutment means must be removable or reversible, so that the user can easily deactivate them in order to separate the reservoir from the outer casing. It must be possible to disengage these two parts manually without using a tool. An axial and/or rotational displacement must be sufficient to uncouple the two parts.

In accordance with a practical embodiment, the axial abutment means comprise at least one peripheral bearing flange formed by one of the neck and the threaded bushing and at least one lug formed by the other of the neck and the threaded bushing, the lug being intended to come into axial alignment with the peripheral bearing flange by mutual rotation of the neck in the threaded bushing, and into mutual axial bearing by axial thrust on the neck.

Advantageously, the neck and the threaded bushing may also together form rotational abutment means for preventing the neck from turning in the threaded bushing, in particular when screwing the threaded ring onto the threaded bushing. The neck is then locked inside the threaded bushing both axially and in rotation: it can be said that the neck is secured to the bushing, preferably in a removable or reversible manner.

In accordance with a practical embodiment, that of the neck and the threaded bushing already forming the peripheral bearing flange may also form an axial locking flange against which the lug is urged into abutment, when the neck is driven in rotation in the threaded bushing. Preferably, the peripheral bearing flange and the axial locking flange are connected together, substantially at right angles.

In addition, that of the neck and the threaded bushing already forming the peripheral bearing flange may also form an access ramp for bringing the lug into axial alignment with the peripheral bearing flange.

In accordance with another aspect, that of the neck and the threaded bushing already forming the axial locking flange may also form an access ramp for bringing the lug into abutment against the axial locking flange.

Preferably, the peripheral bearing flange and the access ramp are connected together, forming an obtuse angle, for example of the order of 150 degrees.

In summary, the lugs, which may be three in number, for example, are displaced by rotation of the neck in the bushing until they come into contact with their respective access ramps. Continuing the rotation guides the lugs, by sliding on the ramps, up to their respective peripheral bearing flanges: the lugs and the peripheral bearing flanges are then axially aligned in pairs. Continuing the rotation guides the lugs by sliding along their respective peripheral bearing flanges, guiding them into abutment against their respective axial locking flanges.

Screwing the dispensing member onto the threaded bushing urges the lugs into bearing contact against their respective peripheral bearing flanges, while remaining in abutment against their respective axial locking flanges. Sealing is provided by compression of a neck seal on the annular edge of the neck or by a self-sealing lip.

The overall arrangement is comparable to a bayonet fastening, in which a lug or pin is guided into a housing forming a ramp that results in a final position which is axially and rotationally locked. The housings may be formed by the neck and the lugs by the casing, or vice versa.

It should be noted that this overall arrangement (axial abutment means+rotational abutment means+possible access ramp) may be implemented in any casing, which does not necessarily comprise a shell and a cover. Thus, individual protection could be sought for this overall arrangement. The casing could, for example, form an open bottom. The reservoir is then introduced neck-first via the open bottom of the casing. The reservoir is displaced axially in the casing until the neck engages inside the threaded bushing. An axial and/or rotational displacement makes it possible to assemble the axial abutment means. Subsequent screwing of the dispensing member onto the threaded bushing makes the axial abutment and sealing effective.

Preferably, the fluid product reservoir comprises a rigid end piece and a flexible pouch, the rigid end piece forming a securing zone and the neck, the flexible pouch being connected to the securing zone in an impervious manner. This is an advantageous embodiment for a reservoir with a variable volume. A deformable canister or a follower piston system may also be used in the context of the invention.

The flanges and ramps may be formed by the neck and the lugs by the cover, or vice versa.

Two operating modes are possible with such a two-part design (shell and cover) . The first consists of introducing the pouch of the reservoir into the outer shell, then attaching the cover to the neck of the reservoir. It is then driven in rotation in order to screw it onto the shell. In this way, the lugs will come into engagement with the ramps in order to guide them respectively into engagement with the peripheral bearing flanges and the axial locking flanges. This requires that the pouch does not rotate in the outer shell when engaging the lugs with the ramps and flanges. The rotational locking of the pouch in the shell can be ensured by friction.

The second mode of operation consists of mounting the cover on the reservoir before introducing it into the outer shell. The user can grasp the pouch with one hand and the cover with the other hand: a rotation of the cover on the reservoir makes it possible to bring the lugs into engagement with the ramps and flanges. The pouch can then be inserted into the outer shell and the cover screwed onto the shell.

In both modes of operation, it is then sufficient to attach the dispensing member to the threaded bushing of the cover and to screw the threaded ring onto the bushing. When screwing is complete, the lugs are respectively urged against the peripheral bearing flanges. Screwing the ring onto the bushing has the effect of pushing the neck downwards inside the casing.

The inventive concept resides in locking the reservoir axially, and advantageously also rotationally, in the casing so as to be able to screw the threaded ring of the dispensing member onto a threaded bushing of the casing, which may be made in two parts. The invention is applicable to any dispenser, but more particularly to a refillable dispenser, in which the reservoir (of fixed or variable volume) constitutes a replaceable element.

In the figures:

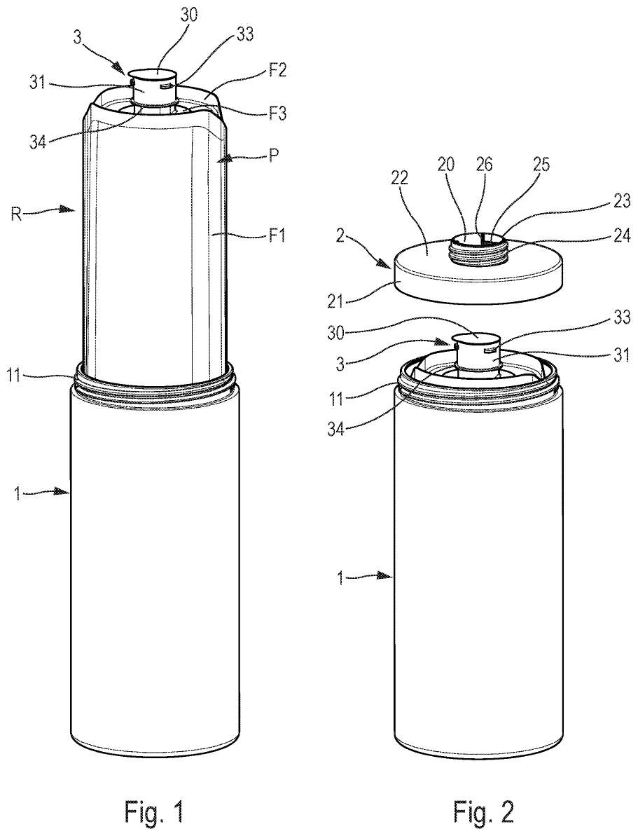

FIG. 1 is a perspective view showing a reservoir ready to be inserted into an outer shell,

FIG. 2 is a perspective view of an outer shell (with its reservoir) ready to receive a cover in order to complete the outer casing,

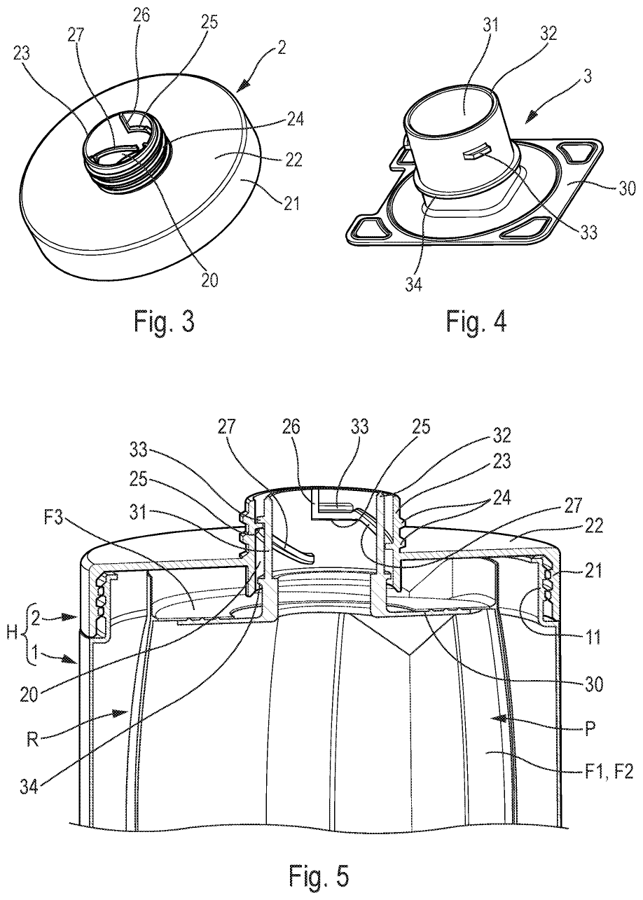

FIG. 3 is a perspective view of the cover of FIG. 2, and

FIG. 4 is a perspective view of the rigid end piece of the reservoir of FIG. 1;

FIG. 5 is a vertical cross sectional view through the reservoir of FIG. 1 disposed inside the casing of FIG. 2,

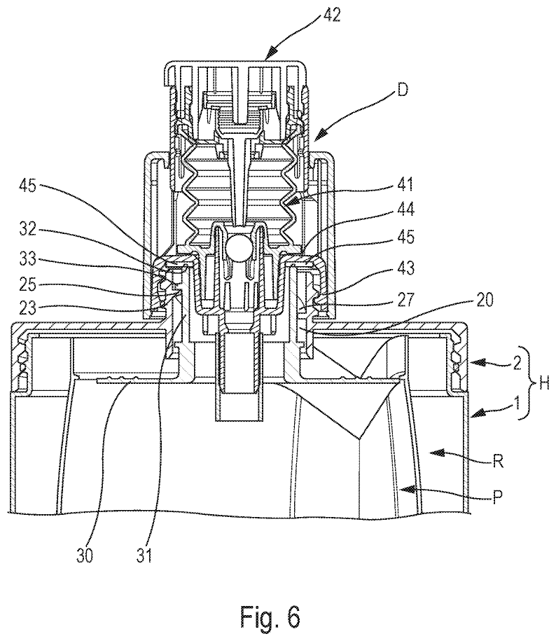

FIG. 6 is a vertical cross sectional view through a dispenser in accordance with the first embodiment of the invention,

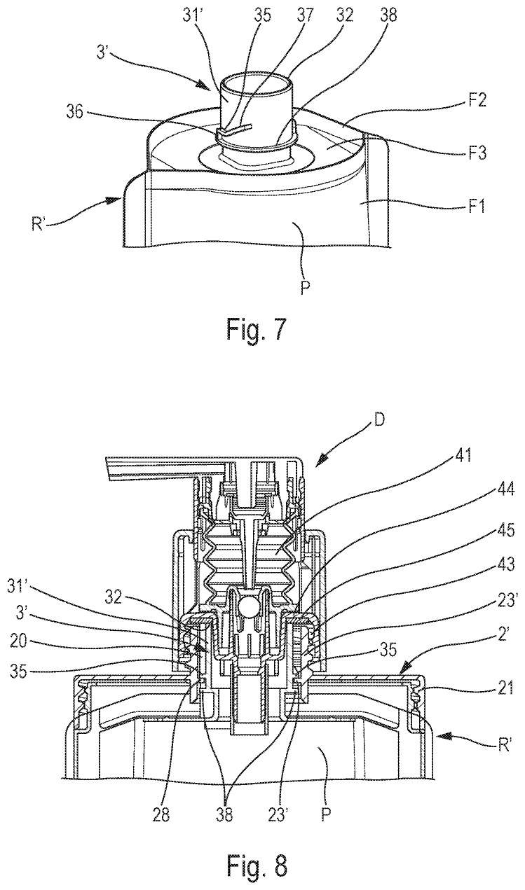

FIG. 7 is a perspective view of a cover in accordance with a second embodiment of the invention, and

FIG. 8 is a view similar to that of FIG. 6 for a dispenser in accordance with this second embodiment of the invention,

Reference is made firstly to FIGS. 1 to 6 in order to describe the first embodiment of the invention. As can be seen in these figures, the dispenser comprises three constituent elements, namely an outer casing H, a fluid product reservoir R, and a dispensing member D. The reservoir R is received inside the casing H and the dispensing member D is removably mounted on the casing H in communication with the reservoir R.

The fluid product reservoir R may be of any kind, provided that it defines a neck, which makes it possible for the interior of the reservoir to communicate with the exterior. The fluid product reservoir R may be rigid, but for reference it has a variable volume. Reservoirs with variable volumes which are already known include deformable canisters and follower piston systems. The example in FIGS. 1 to 6 here uses a reservoir R with a flexible pouch. More precisely, the reservoir R comprises a rigid end piece 3 and a flexible pouch P. The rigid end piece 3 forms a securing zone 30, which can be seen in FIGS. 4, 5 and 6, and a neck 31. The flexible pouch P is connected to the securing zone 30 in a sealed manner, for example by welding or bonding. The flexible pouch P here is of a particular type: in fact, it is formed from four sheets, namely two main sheets F1 and F2 connected together to form a cylinder, a top sheet F3 secured on the securing zone 30 and a bottom sheet. The top sheet F3 and the bottom sheet are connected to the main sheets F1 and F2. This pouch P produced from four sheets has the advantage of defining a large useful volume while being capable of dispensing a maximum of fluid product. Clearly, this is merely a non-limiting example.

In FIGS. 4, 5 and 6, it can be seen that the neck 31 of the rigid end piece 3 extends upwards from the securing zone 30. The neck 31 defines an annular upper edge 32, as well as several lugs 33, which extend radially outwards from the outer wall of the neck 31. By way of example, it is possible to provide three lugs 33. Each lug 33 may be in the form of a small horizontal slat. Below the lugs 33, close to the securing zone 30, the neck 31 forms an annular collar 34 that projects radially outwards. The function f this collar will be described below. Finally, the neck 31 may initially be closed by a seal 30, which is secured to the annular upper edge 32 of the neck 31 in an impervious manner.

The casing H may be produced as a single piece with an open bottom in order to enable the reservoir R to be inserted. Preferably, the casing H comprises two separate constituent elements, namely an outer shell 1 as well as a cover 2 which is attached to the outer shell 1. This outer shell 1 may simply be in the form of a cylinder comprising a threaded upper edge 11. The bottom of the shell 1 may be open or closed. The cross section of the outer shell 1 may be circular, or have other geometric shapes depending on the configuration of the reservoir R.

The cover 2 comprises a threaded skirt 21 adapted to come into threaded or screw engagement with the threaded edge 11 of the outer shell 1. The cover 2 also includes an annular plate 22, which may be flat or inclined. The cover 2 comprises a bushing 23 that internally defines an opening 20. Externally, the bushing 23 is provided with a thread 24. Internally, the bushing 23 forms several flanges that project radially inwards. Firstly, there is a peripheral axial bearing flange 25 that extends horizontally. Next, there is a vertical axial rotational locking flange 26 the lower end of which connects to the peripheral bearing flange 25. There is also a ramp 27, which is in the form of an inclined flange which connects to the other end of the peripheral bearing flange 25. These three flanges 25, 26 and 27 form a set of flanges and it is necessary to provide as many sets of flanges as there are lugs 33. In the embodiment illustrated in the figures, there are three lugs 33 and three sets of flanges.

FIG. 5 clearly shows the cooperation between the bushing 23 and the neck 31, and more particularly the cooperation between the lugs 33 of the neck 31 and the flanges 25, 26 and 27 of the bushing 23. Two lugs 33 can be seen, resting on two peripheral bearing flanges 25: these two lugs 33 also come to abut against the axial rotational abutment flanges 26. The lugs 33 are therefore locked both axially and in rotation. In order to reach this position shown in FIG. 5, the lugs 33 can slide on the ramps 27 by rotation of the neck 31 inside the bushing 23 in the counterclockwise direction. The axial retention of the neck 31 inside the bushing 23 is additionally reinforced by the annular collar 34 of the neck 31 which almost makes contact with the inner wall of the bushing 23. It should also be observed in FIG. 5 that the threaded skirt 21 of the cover 2 is in threaded engagement with the threaded upper edge 11 of the outer shell 1.

Reference will now be made to FIG. 6, which shows a dispensing member D, mounted on the casing H and the reservoir R of FIG. 5. The dispensing member D may be of a design that is entirely conventional. It firstly comprises a pump 41, which in this case is a bellows pump. The dispensing member D also includes an actuator 42 on which the user can press with the aid of a finger in order to actuate the pump 41. The dispensing member D is also provided with a threaded ring 43, which is in threaded engagement with the thread 24 of the bushing 23. The dispensing member D also includes a bearing plate 44 that enables a neck seal 45 to be compressed against the annular upper edge 32 of the neck 31. To this end, it should be noted in FIG. 6 that this annular upper edge 32 protrudes slightly from the bushing 23, in order to enable the neck seal 45 to be compressed. The removable attachment is therefore ensured by the threaded ring 43 in threaded engagement with the thread 24 of the bushing 23 and the seal is ensured by the compression of the neck seal 45 by the bearing plate 44 on the annular upper edge 32 of the neck 31. The neck seal 45 does not need to come into impervious contact with the bushing 23.

It should be noted that the lugs 33 bear strongly on the peripheral bearing flanges 25. In other words, the rigid end piece 3 is pushed downwards by the dispensing member D inside the casing H.

During the assembly operation, the cover 2 is firstly removed from the outer shell 1. The reservoir R can then be inserted into the outer shell 1, as shown in FIG. 1. The reservoir R can be prevented from rotating inside the shell 1 by the friction of the sheets F1 and F2 against the inner wall of the shell 1 or by the shape of the shell 1.

Once the reservoir R is inside the shell 1, as shown in FIG. 2, the cover 2 may be attached to the outer shell 1 and driven in rotation in a manner such as to bring the lugs 33 onto the peripheral bearing flanges 25 and into contact with the axial rotational abutment flanges 26 by sliding on the ramps 27. By continuing the rotation of the cover 2 on the shell 1, the threaded skirt 21 also comes into threaded engagement with the threaded upper edge 11 of the shell 1. Thus, in a single rotational movement, the cover 2 is attached to the shell 1 and the lugs 31 are engaged with the flanges 25 and 26.

In a variation, the cover 2 may be mounted on the reservoir R first. Next, the reservoir R, with the cover 2 mounted thereon, can be introduced into the outer shell 1 and finally, the cover 2 can be screwed onto the outer shell 1. This second procedure does not require the pouch to be locked inside the outer shell.

Reference is made to FIGS. 7 and 8, which show a second embodiment which reverses the position of the lugs 33 and the flanges 25, 26 and 27. In FIG. 7, it can be seen that the neck 31′ of the rigid end piece 3′ forms a peripheral bearing flange 35, as well as a ramp 37 that is inclined upwards. The neck 31′ also forms an axial rotational abutment flange 36, which is connected to the peripheral bearing flange 35. The axial rotational abutment flange 36 is then extended by an annular collar 38. Just as in the first embodiment, there are as many sets of flanges 35, 36 and 37 as there are lugs, namely three.

In FIG. 8, it can be seen that the dispensing member D may be identical to that of the first embodiment. However, the cover 2′ differs from that, 2, of the first embodiment in that the bushing 23′ internally forms three lugs 28, in place of the flanges 25, 26 and 27. These lugs 28 respectively cooperate with the sets of flanges 35, 36 and 37 in the same manner as in the first embodiment, but in an inverted manner. The lugs 28 slide along the ramps 37 in order to become lodged against both the peripheral flanges 35 and the axial flanges 36. Consequently, screwing the dispensing member D has the effect of pushing the lugs 28 against the peripheral flanges 35, given the axial thrust exerted on the annular upper edge 32 of the neck 31′ by the neck seal 45 which is urged by the bearing plate 44.

Consequently, the lugs can be formed on the outside of the neck 31 or on the inside of the bushing 23′. Similarly, the sets of flanges can be formed inside the bushing 23 or outside the neck 31′. In both cases, the lugs 33 or 28 come into engagement with their respective sets of flanges when the cover 2 or 2′ is screwed onto the outer shell 1. The user does not need to carry out a prior operation in order to engage the lugs with their respective flange assemblies. Simply rotating the cover 2 or 2′ on the outer shell 1 is sufficient to carry out this operation imperceptibly.

The casing H is shown here in two parts, namely an outer shell 1 and a cover 2 or 2′. However, in the case of a one-piece casing, the engagement of the lugs 33 or 28 with their respective sets of flanges requires a prior operation, since it is necessary to engage the reservoir R inside the outer shell 1 via its open bottom, then to rotate the reservoir inside the casing in order to engage the lugs with their respective sets of flanges. It is obvious that this operation is not intuitive, because the user does not know that it is necessary to rotate the reservoir R inside the casing in order to lock it axially and in rotation. £ This is why the first embodiment with a two-piece casing is preferred.

Instead of the neck seal 45, a self-sealing lip that comes into sealed contact around the neck 31 or 31′ may also be envisaged. The axial rotational locking flanges 26 and 36 and the ramps 27 and 37 are optional, but preferable.

It should of course be noted that screwing the threaded ring 43 onto the bushing 23 has the effect of pushing the neck 31 or 31′ inside the casing, which allows the lugs 33 or 28 to abut with their peripheral bearing flanges 35 or 25.

1. A fluid product dispenser, comprising:
a fluid product reservoir forming a neck defining an annular upper edge,
an outer casing comprising a threaded bushing defining a central opening for the passage of the neck, the fluid product reservoir extending in the casing along a longitudinal axis X,
a dispensing member provided with a threaded ring intended to come into threaded engagement with the threaded bushing of the outer casing, the dispensing member coming to bear axially on the neck when screwing of the threaded ring onto the threaded bushing is complete,
the neck and the threaded bushing together forming axial abutment means for axially locking the neck in the threaded bushing by axial thrust of the dispensing member on the neck,
characterized in that the outer casing comprises:
an outer shell forming a threaded upper edge, and
a cover comprising a threaded skirt intended to come into threaded engagement with the threaded upper edge of the outer shell, the cover forming the threaded bushing defining the central opening for the passage of the neck of the fluid product reservoir.

2. The dispenser as claimed in claim 1, in which the neck and the threaded bushing together form rotational abutment means for preventing the neck from turning in the threaded bushing in particular when screwing the threaded ring onto the threaded bushing.

3. The dispenser as claimed in claim 1, in which the axial abutment means comprise axial abutment means comprising at least one peripheral bearing flange formed by one of the neck and the threaded bushing and at least one lug formed by the other of the neck and the threaded bushing, the lug being intended to come into axial alignment with the peripheral bearing flange by mutual rotation of the neck in the threaded bushing and into mutual axial abutment by axial thrust on the neck.

4. The dispenser as claimed in claim 3, in which that of the neck and the threaded bushing already forming the peripheral bearing flange also forms an axial locking flange against which the lug is urged into abutment, when the neck is driven in rotation in the threaded bushing.

5. The dispenser as claimed in claim 4, in which the peripheral bearing flange and the axial locking flange are connected together, substantially at right angles.

6. The dispenser as claimed in claim 3, in which that of the neck and the threaded bushing already forming the peripheral bearing flange also forms an access ramp for bringing the lug into axial alignment with the peripheral bearing flange.

7. The dispenser as claimed in claim 4, in which that of the neck and the threaded bushing already forming the axial locking flange also forms an access ramp for bringing the lug into abutment against the axial locking flange.

8. The dispenser as claimed in claim 6, in which the peripheral bearing flange and the access ramp are connected together, forming an obtuse angle.

9. The dispenser as claimed in claim 1, in which the dispensing member comprises an annular plate that compresses a neck seal on the annular upper edge of the neck.

10. The dispenser as claimed in claim 1, in which the fluid product reservoir comprises a rigid end piece and a flexible pouch, the rigid end piece forming a securing zone and the neck the flexible pouch being connected to the securing zone in an impervious manner.

11. The dispenser as claimed in claim 1, in which the fluid product reservoir is locked against rotation in the outer shell during mounting of the cover on the fluid product reservoir.
